(19) United States
(12) Patent Application Publication
(10) Pub. No.: US 2002/0138240 A1
(43) Pub. Date: Sep. 26, 2002

(54) Method and apparatus for predicting an operating characteristic of a rotary earth boring bit

(76) Inventors: David John Jelley, Cheltenham (GB); Brian Peter Jarvis, Chipping Sodbury (GB)

Correspondence Address: SCHLUMBERGER OILFIELD SERVICES, JEFFREY E. DALY, 7211 N. GESSNER, HOUSTON, TX, 77040, US

(21) Appl. No.: 10/063,243

(22) Filed: Apr. 2, 2002

Related U.S. Application Data
(63) Continuation of application No. 09/634,193, filed on Aug. 9, 2000.

(30) Foreign Application Priority Data
Apr. 15, 2000 (GB) GB0009266.8

(51) Int. Cl. G06G 7/48

(52) U.S. Cl. 703/7

(57) ABSTRACT

The present invention is a method and apparatus which accurately predicts one or more operating characteristics of an earth boring drill bit operated under a set of known operating conditions. A range of operating conditions may be input so that the operating characteristic(s) of the drill bit may be predicted over, and perhaps beyond the range the drill bit designer has anticipated. In this manner, a new drill bit design may be refined and/or proven with a high level of confidence prior to manufacture. Only minimal field testing of the new design is required to verify its performance.

### CROSS REFERENCE TO RELATED APPLICATIONS

This application is a Continuation of U.S. patent application Ser. No. 09/634,193 filed on Aug. 9, 2000 hereby incorporated herein by reference, which claims priority from United Kingdom Patent Application GB 0009266.8, filed Apr. 15, 2000.

### BACKGROUND OF INVENTION

1. Field of the Invention.

The invention relates to methods and apparatus for predicting one or more operating characteristics of a rotary earth boring drill bit based upon its design parameters and operating conditions. A neural network trained with the results of physical testing is used to predict one or more operating characteristics of a drill bit design under a variety of operating conditions.

2. Description of the Related Art.

The invention is applicable to all forms of earth boring drill bits. In one type of drill bit all of the cutters are preform cutters formed, at least in part, from polycrystalline diamond or other superhard material. One common form of cutter comprises a tablet, usually circular or part circular, made up of a superhard table of polycrystalline diamond, providing the front cutting face of the cutter, bonded to a substrate which is usually of cemented tungsten carbide.

The invention is also applicable to drill bits where the cutting structures comprise particles of natural or synthetic diamond, or other superhard material, embedded in a body of less hard material. The cutting structures may also comprise regions of a larger substantially continuous body comprising particles of superhard material embedded in a less hard material.

The bit body may be machined from solid metal, usually steel, or may be molded using a powder metallurgy process in which tungsten carbide powder is infiltrated with a metal alloy binder in a furnace so as to form a hard matrix.

The outer extremities of the cutters or other cutting structures on the drill bit define an overall cutting profile which defines the surface shape of the bottom of the borehole which the drill bit drills. Preferably, the cutting profile is substantially continuous over the leading face of the drill bit so as to form a comparatively smooth bottom hole profile.

In all of the above described drill bits, the cutting action is effected by a scraping or gouging action as the cutters are pushed into the earth and the bit body is rotated.

The invention is also applicable to the type of drill bits with one or more rolling cone cutter bodies mounted upon corresponding legs projecting from a bit body. A number of hard, wear resistant cutting elements are mounted upon the rolling cone cutters. These drill bits usually have sealed and lubricated bearing systems in each rolling cone cutter. Although rolling cutter drill bits may have as few as one, and as many as several dozen rolling cone cutters, the configuration with three rolling cone cutters is the most common.

In all rolling cutter type earth boring drill bits, the cutting elements on the rolling cutters engage the earth. When the body of the drill bit is rotated, the cutting elements are driven by the earth, causing the cutter bodies to rotate, effecting a drilling action.

All types of earth boring drill bits are expected to perform well in a variety of drilling conditions. The challenge for the drill bit designer is to make a design for a new drill bit that can be put out on the market quickly at a relatively low cost for design. Unfortunately, there are a great many drill bit design parameters that change dramatically, even with relatively minor changes in drilling application conditions. Typically, candidate drill bit designs are laboratory tested and field tested numerous times before the new drill bit is ready for sale. This is not only expensive, it is also time consuming.

In order to more efficiently design new drill bits, a number of analytical tools have been developed to aid in the design process. It is common practice to use computers to model and analyze drill bit designs. Methods of analysis have previously been proposed and used for predicting cutter wear and other characteristics related to drill bit performance. Such analysis is usually carried out by constructing a specific computerized model or representation of a particular drill bit design. A computer algorithm is then designed to perform a series of steps on the computerized model of the drill bit in order to predict or optimize those characteristics. Any design change in the drill bit would require a new drill bit model.

For Example, in U.S. Pat. No. 4,475,606 a methodology for designing a fixed cutter drill bit is disclosed which determines cutter placement on the bit body, based upon a constant annular area between adjacent cutters. Other methodologies for drill bit designs based upon mathematical formulas or other analytical means are disclosed in U.S. Pat. Nos. 5,937,958, 5,787,022, 5,605,198, and British Patent Publications 2,300,308, 2,241,266. Although these methodologies help the drill bit designer reach an optimal design more quickly, significant design iteration is still necessary to produce a drill bit that performs satisfactorily. Additionally, the methodologies require that the model itself be changed for each new drill bit design.

While existing methods may provide useful comparisons between various designs of drill bits, the existing methods are unable to predict useful operating characteristics of a drill bit when the drill bit is operated under a number of given operating conditions. Existing methods typically only help the designer to arrange the physical design elements to obtain optimum placements of those elements. The existing methods also generally assume that the wear rate of the cutting structures is substantially constant over the life of the drill bit, which may not be the case.

In more recent years, new computer aided mathematical modeling has been used for control of drilling operations in real time in order to optimize the drilling operation, as shown for example in U.S. Pat. Nos. 6,026,911 and 6,026,912. In addition, neural network computer programs have been used to help optimize oilfield reservoir production or related activities as disclosed in U.S. Pat. Nos. 5,444,619, 6,002,985, 5,625,192, 5,251,286, and 5,181,171. More information on the design and function of neural networks is disclosed in U.S. Pat. Nos. 5,150,323 and 4,912,655.

Although the need is clearly evident, prior to the present invention, there has been no known form of earth boring drill bit modeling which is able to predict an operating characteristic of a drill bit from a set of inputs based upon drill bit design parameters and a set of anticipated operating conditions.

### SUMMARY OF INVENTION

The present invention is a method and apparatus which accurately predicts one or more operating characteristics of an earth boring drill bit operated under a set of known operating conditions. A range of operating conditions may be input so that the operating characteristic(s) of the drill bit may be predicted over, and perhaps beyond the range the drill bit designer has anticipated. In this manner, a new drill bit design may be refined and/or proven with a high level of confidence prior to manufacture. Only minimal field testing of the new design is required to verify its performance.

The device to predict operating characteristics of a drill bit comprises a numeric algorithm operating in a digital computer that takes in as input a first set of numbers (that may be dimensionless) representing drill bit design parameters and a plurality of second sets of numbers representing operating conditions of the drill bit. The numeric algorithm outputs one or more operating characteristics of the drill bit at each set of operating conditions. The set of output operating characteristics of the drill bit represents the drilling behavior and performance of the drill bit with the given design parameters and set of operating conditions.

The numeric algorithm is generated by a method utilizing a neural network comprising the steps of: a)determining a set of drill bit design parameters; b) determining a set of drill bit operating conditions; c)collecting a set of one or more measured drill bit operating characteristics from tests of a plurality of drill bits operated in a plurality of operating conditions; d)training the neural network by inputting each measured drill bit operating characteristic for each set of drill bit design parameters and each set of operating conditions; and e)generating a numeric algorithm from the trained neural network in the form of a set of instructions comprising a series of mathematical operations which predicts an operating characteristic of a drill bit made in accordance with the drill bit design parameters and run under a given drill bit operating condition.

The method may comprise the further step of: f)programming a digital computer with the numeric algorithm such that one or more of the drill bit operating conditions are incremented over one or more ranges to predict the overall drilling behavior and performance of the drill bit.

One or more of the drill bit design parameters may be selected from: bit diam., cone volume index 1, cone volume index 2, asymmetry index, drill bit gauge type, shear length index, cut area index, profile length index, profile base moment, profile center moment, profile base 2nd moment, profile center 2nd moment, cut area base moment, cut area center moment, and bit volume index.

For many types of fixed cutter drill bits the preferred drill bit design parameters are: gauge ring, asymmetry index, shear length index, profile center second moment, and the cut area base moment.

Typical drill bit operating conditions may be selected from: drill bit rpm, weight on bit, rock type, drilling depth, mud weight, build angle, and bent sub angle. However, for many types of fixed cutter drill bits the preferred drill bit operating conditions are bit rpm, weight on bit, and rock type.

Typical drill bit operating characteristics may include but are not limited to: lateral acceleration, torsional acceleration, torque, and longitudinal acceleration. However, for fixed cutter drill bits, lateral acceleration is a preferred operating characteristic to predict.

### BRIEF DESCRIPTION OF DRAWINGS

FIG. 1 is a perspective view of one kind of drill bit of the general type to which the invention is applicable.

FIG. 2 is a perspective view of a second kind of drill bit of the general type to which the invention is applicable.

FIG. 3 is a perspective view of a third kind of drill bit of the general type to which the invention is applicable.

FIG. 4 is a perspective view of a fourth kind of drill bit of the general type to which the invention is applicable.

FIG. 5 is graphic outline of one type of fixed cutter drill bit cutting face configuration.

FIGS. 6 to 10 are graphic outlines of various other types of fixed cutter drill bit cutting face configurations.

FIG. 11 is a graph showing characteristics measured from the drill bit laboratory testing overlaid with characteristics predicted from the trained neural network.

FIG. 12 is a block diagram of an apparatus for predicting an operating characteristic of a rotary earth boring drill bit.

### DETAILED DESCRIPTION

Referring now to FIG. 14 there are shown perspective views of four types of earth boring drill bits to which the method and apparatus of the present invention may be applied. In FIG. 1 there is shown what is known as a fixed cutter PDC type drill bit. The bit body 10 is typically machined from steel and has a threaded shank 12 at one end for connection to the drill string. The operative end face 13 of the bit body is formed with a number of blades 14 radiating outwardly from the central area of the drill bit, the blades carrying cutters 16 spaced apart along the length thereof.

The drill bit gauge section includes kickers 18 which contact the walls of the borehole in use, to stabilize the drill bit in the borehole. A central passage (not shown) in the bit body and shank delivers drilling fluid through nozzles mounted in the bit body, in known manner, to clean and cool the cutters.

Each cutter 16 comprises a preform cutting element comprises a circular tablet having a front facing table 20 of polycrystalline diamond, providing the front cutting face of the element, bonded to a substrate.

It will be appreciated that this is only one example of many possible variations of the type of drill bit and cutter to which the method and apparatus of the present invention is applicable.

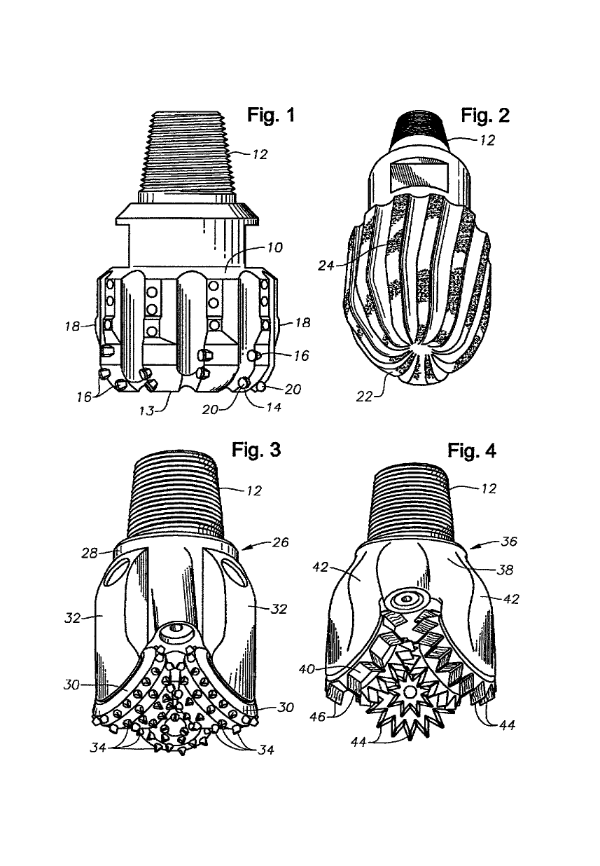

In another type of drill bit, as shown in FIG. 2, the cutting structures on the drill bit may have cutting surfaces 22 with a substantially continuous layer of cutter material comprising natural or synthetic diamond or other superhard particles 24. If the superhard particles are large and mounted on or near the cutting surfaces 22, the drill bit is known as a diamond type drill bit. If the cutting surfaces 22 have major portions which are made of a mixture of small, superhard particles throughout, the drill bit is known as a diamond impregnated type drill bit.

Rolling cutter type drill bits are shown in FIGS. 3 and 4. An insert type rolling cutter drill bit 26 shown in FIG. 3 has a bit body 28 with one or more rolling cone cutter bodies 30 mounted upon corresponding legs 32 projecting from the bit body 28. A number of hard, wear resistant cutting elements 34 are mounted upon the cutter bodies 30. These drill bits 26 usually have sealed and lubricated bearing systems (not shown) in each rolling cone cutter.

A tooth type rolling cutter drill bit 36 shown in FIG. 4 also has a bit body 38 with one or more rolling cone cutter bodies 40 mounted upon corresponding legs 42 projecting from the bit body 38. Teeth 44 are formed on the cutter bodies 40, usually integrally, in a machining process or a rapid solid state densification powdered metallurgy process. A layer of wear and erosion material 46 is typically formed with or applied to the teeth 44 on the cutter bodies 40. These drill bits 36 may have sealed and lubricated bearing systems in each rolling cone cutter, but unsealed tooth type drill bits 36 are also common.

Typically, most rolling cutter drill bits 26, 36 have three rolling cone cutters, although drill bits with as few as a single rolling cone cutter and as many as several dozen rolling cone cutters are known in the industry. In all rolling cutter type earth boring drill bits, the cutting elements on the rolling cutters engage the earth. When the body of the drill bit is rotated, the cutting elements are driven by the earth, causing the cutter bodies to rotate, effecting a drilling action.

The method and apparatus for predicting an operating characteristic for a drill bit from a set of given drill bit design parameters, and a set of operating conditions applies to all types of the aforementioned drill bits. However, since the method and apparatus was initially perfected on fixed cutter drill bits the following discussion is focused upon the embodiment of the present invention dealing with fixed cutter PDC type drill bits.

The method for predicting an operating characteristic for a drill bit from a set of given drill bit design parameters, and a set of operating conditions comprises the steps of: a)determining a set of drill bit design parameters; b)determining a set of drill bit operating conditions; c)collecting a set of one or more measured drill bit operating characteristics from tests of a plurality of drill bits operated in a plurality of operating conditions; d)training the neural network by inputting each measured drill bit operating characteristic for each set of drill bit design parameters and each set of operating conditions; and e)generating a numeric algorithm from the trained neural network in the form of a set of instructions comprising a series of mathematical operations which predicts an operating characteristic of a drill bit made in accordance with the drill bit design parameters and run under a given drill bit operating condition.

The following discussion provides an example of how this method may be applied to a particular type of fixed cutter PDC type drill bits. Although the steps of the method apply to all types of drill bits; the details provided in the example are specific to this one type of drill bit. The example is provided only to help in understanding the method and is not to be construed as to limit the scope of the method of the invention in any manner whatsoever.

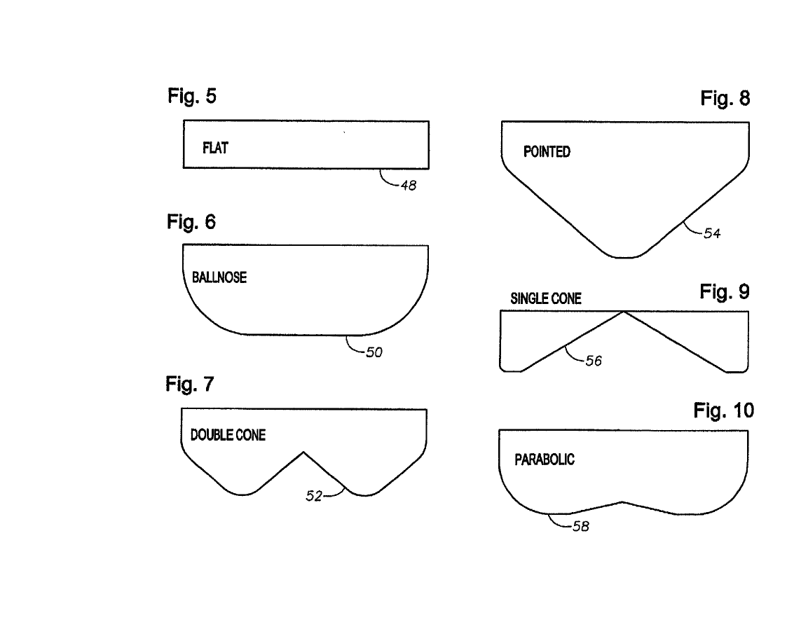

In the first step of the method, determining a set of drill bit design parameters; the various factors that differentiate one drill bit design from another must be determined. In determining these factors, several aspects of fixed cutter drill bits must be considered. In FIGS. 5-10, six basic cutting face configurations for fixed cutter drill bits are shown.

In FIG. 5, a flat drill bit cutting face configuration is shown as indicated by numeral 48.

In FIG. 6, a ballnose drill bit cutting face configuration is shown as indicated by numeral 50.

In FIG. 7, a double cone drill bit cutting face configuration is shown as indicated by numeral 52.

In FIG. 8, a pointed drill bit cutting face configuration is shown as indicated by numeral 54.

In FIG. 9, a single cone drill bit cutting face configuration is shown as indicated by numeral 56.

In FIG. 10, a parabolic drill bit cutting face configuration is shown as indicated by numeral 58.

A single set of drill bit design parameters must be identified which is capable of characterizing all these types of drill bits. Many drill bit design parameters were initially considered and eliminated. These include: the bit diameter, number of blades, the quantity and predominant size of the cone cutters, the quantity and predominant size of the nose cutters, the quantity and predominant cutter size of the shoulder cutters, the cone cutter back rake, the nose cutter back rake, the shoulder cutter back rake, the out of balance force, the profile height index, the normalized shear length, the tip profile height, percent angular circumference of gauge, gauge pads, a series of nominal volume and exposure indices and the normalized PDC area—just to name a few. In the present example, it was decided that only one diameter of bit would be used, and therefore the bit diameter design parameter was eliminated. It is anticipated, however, that the bit diameter will be included in future sets of bit design parameters. Although the remainder of these design parameters appeared at first to be good candidates for relevant design parameters, in this example, they were all ultimately eliminated.

Eventually, fourteen drill bit design parameters were chosen which were considered relevant for this particular example because their values varied for the different bits included in the example. These fourteen drill bit design parameters are shown in Table 1.

DRILL BIT DESIGN PARAMETERS SELECTED

| Design Paramater | Represented by |
|---|---|
| Cone Volume | (Cone volume)/(Bit Vol.) |
| Index 1 | |
| Cone Volume | (Cone volume)/(Bit Encapsulating Cyl. Vol) |
| Index 2 | |
| Asymmetry Index | (Sum of cutter theta angle symmetry discrepancies)/ |
| | (No. of Cutters) |
| Drill Bit Gauge | Gauge ring present or not |
| Type | |
| Shear Length | (Total Cutter Shear Length)/(Bit Diameter) |
| Index | at 100 RPM & 50 ft/h. |
| Cut Area Index | (Total Cut Area)/(Bit Diameter)² |
| | 100 RPM & 50 ft/h. |
| Profile Length | (Bit Profile Length)/(Bit Diameter) |
| Index | |
| Profile Base | (Moment of Area of Half Profile about Base |
| Moment | Datum)/(Bit Diameter)³ |
| Profile Center | (Moment of Area of Half Profile about Bit Center)/ |
| Moment | (Bit Diameter)³ |
| Profile Base 2^{nd} | (2nd Moment of Area of Half Profile about Base |
| Moment | Datum)/(Bit Diameter)⁴ |
| Profile Center 2nd | Moment (2nd Moment of Area of Half Profile about |
| Moment | Bit Center)/(Bit Diameter)⁴ |
| Cut Area Base | (Sum of Moments of Cut Areas about Base Datum)/ |
| Moment | (Total Cut Area* Bit Diameter) at 100 RPM & |
| | 50 ft/h |
| Cut Area Center | (Sum of Moments of Cut Areas about Bit Center)/ |
| Moment | (Total Cut Area* Bit Height) at 100 RPM & |
| | 50 ft/h. |
| Drill Bit Volume | (Bit Volume)/(Encapsulating Cylinder Volume) |
| Index | |

As noted earlier, these drill bit design parameters are specific to this example of the method for fixed cutter PDC type drill bits, and it would be appreciated by one skilled in the art that different sets of drill bit design parameters are likely to be selected for the other types of drill bits.

In order to simplify the bit design process, it is desirable to reduce the number of design parameters to the smallest possible set that will still provide accurate predicted bit operating characteristics. Further refinement to the list of drill bit design parameters is made by creating a trial neural network utilizing all the drill bit design parameters and training it with all the tested drill bit operating conditions and operating characteristics.

The sensitivity of each of the fourteen (14) selected drill bit design parameters listed in Table 1 was considered. The output of this series of neural network training runs was used to determine which of the drill bit design parameters has a significant influence on the accuracy of the predicted output characteristic when compared to that of the test data set. Generally, many of the initially determined drill bit design parameters can be eliminated by this process.

The set of drill bit design parameters for fixed cutter drill bits in this particular example was reduced from the original fourteen (14) to five (5) during the preliminary training exercise. The five (5) drill bit design parameters for the final training of the neural network in this example of the method are: Asymmetry Index, Drill Bit Gauge Type, Shear Length Index, Profile Center 2^{nd} Moment, and Cut Area Base Moment.

Step b of the method, determining a set of drill bit operating conditions, is generally much simpler. The full set of operating conditions can be quite lengthy. However, because the neural network has to be trained with data acquired by testing, the set is generally limited by the test equipment for fixed cutter drill bits to one or more of the following operating conditions: bit rpm, weight on bit, rock type, drilling depth, mud weight, build angle, BHA, and bent sub angle. However, for the fixed cutter PDC drill bit method of the present example, the drill bit operating conditions are bit rpm, weight on bit and rock type.

The sets of drill bit design parameters and drill bit operating conditions for training a neural network and generation of a numeric algorithm in this example the method are listed together in Table 2.

DRILL BIT DESIGN PARAMETERS AND OPERATING
CONDITIONS SELECTED FOR NUMBERIC ALGORITHM

| Parameter/Op. | |
|---|---|
| Condition | Represented by |
| Asymmetry Index | (Sum of cutter theta angle symmetry discrepancies)/ |
| | (No. of Cutters) |
| Drill Bit Gauge | Gauge ring present or not |
| Type | |
| Shear Length | (Total Cutter Shear Length)/(Bit Diameter) |
| Index | at 100 RPM & 50 ft/h. |
| Profile Center 2^{nd} | Moment (2nd Moment of Area of Half Profile about |
| Moment | Bit Center)/(Bit Diameter)⁴ |
| Cut Area Base | (Sum of Moments of Cut Areas about Base Datum)/ |
| Moment | (Total Cut Area* Bit Diameter) at 100 RPM & |
| | 50 ft/h |
| Rotating Condition | Bit revolutions per minute |
| Load Condition | Pounds weight on bit |
| Formation | Rock Type: 1) Carthage Marble 2) Torrey Bluff |
| Condition | Sandstone 3) Colton Sandstone |

The next step, c, of the method is collecting a set of one or more measured drill bit operating characteristics from tests of a plurality of drill bits operated in a plurality of operating conditions. Over a five-year period, a large number of tests were run on a full-scale laboratory drill bit test machine. Sixty-four (64) of these tests were used to train the neural network in this particular example. The data recorded for each test represented 4000 data points representing each of the operating conditions and each of the operating characteristics. Due to the difficulties of working with this large collection of data, the collection of data points was reduced to 816 data points by averaging the data over 0.5 second intervals. This set of 816 drill bit design parameters and drill bit operating conditions was used for training the neural network. Although a number of the following operating characteristics were measured: lateral acceleration, torsional acceleration, torque, and longitudinal acceleration, the operating characteristic of lateral acceleration was chosen in this example to train the neural network in step d.

Training the neural network is accomplished by inputting each measured operating characteristic for each set of drill bit design parameters and each set of operating conditions into a digital computer (or in another suitable neural network device) programmed to provide neural network computations. The computer program then operates upon the neural network such that the best fit of the input parameters and conditions with the tested output characteristics is represented in numerical form.

The drill bit design parameters and the operating conditions of the test data are then input into the computer to test how well the neural network predicts the operating characteristics of the drill bit. If the predicted results closely match the test result then the neural network is considered to be properly trained.

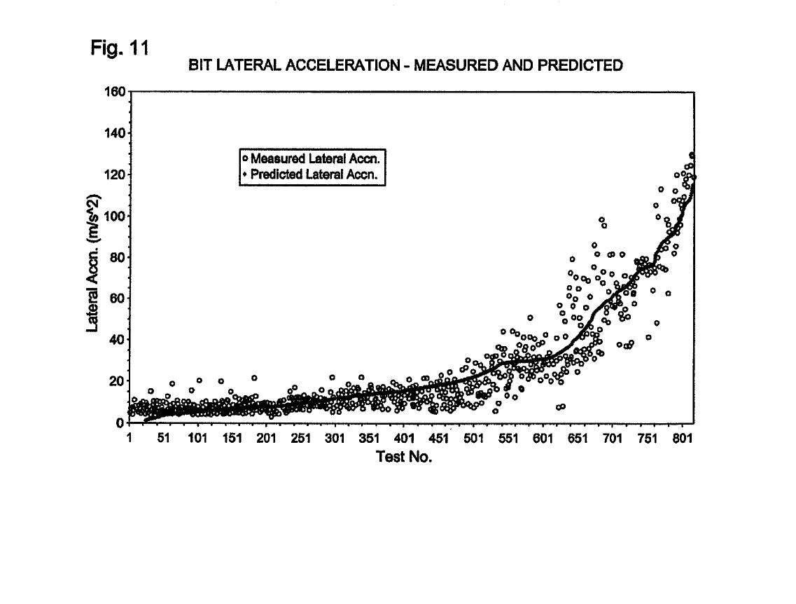

FIG. 11 is a graph showing all 816 data sets and the measured lateral acceleration from the drill bit testing overlaid with the predicted lateral accelerations from the numerical algorithm generated by the trained neural network. As can be seen, in this example of the method, the predicted operating characteristics agree quite well with what was measured in the testing.

The final step in the method, e, is generating a numeric algorithm from the trained neural network in the form of a set of instructions comprising a series of mathematical operations which predicts an operating characteristic of a drill bit made in accordance with the drill bit design parameters and run under a given drill bit operating condition. This numeric algorithm may be output from the trained neural network and be integrated into a program in a digital computer or other suitable device.

The numeric algorithm may, for example, be embedded in a drill bit application program to allow a drill bit user to predict an operating characteristic of a drill bit under a set of operating conditions.

A further step, f, programming a digital computer with the numeric algorithm such that one or more of the drill bit operating conditions are incremented over one or more ranges to predict the overall drilling behavior and performance of the drill bit, may also be added to the method. This allows a drill bit designer to easily characterize a drill bit's performance under the variety of drilling conditions the drill bit may encounter in service. In this manner, the drill bit designer will be able to assure that the drill bit will be able to perform as expected, or that modifications to the design are needed.

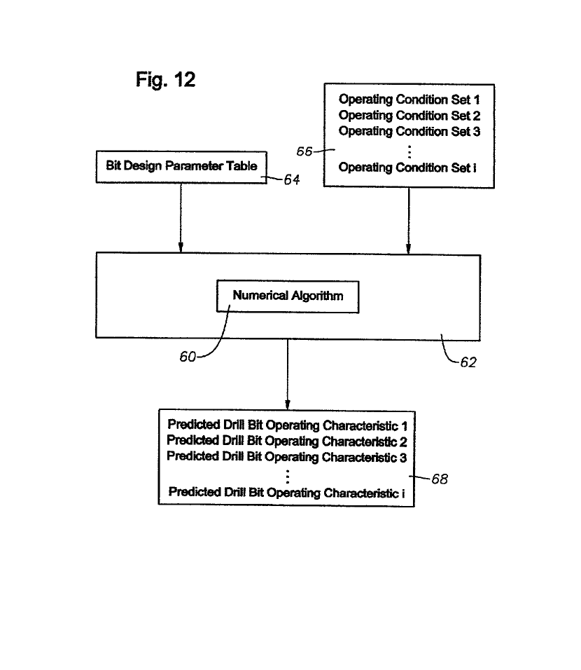

The apparatus of the present invention is shown in block diagram form in FIG. 12. A numeric algorithm 60 operating in a digital computer 62 is stored in the digital computer 62 as a series of coded instructions that perform numeric calculations based upon one or more formulas obtained from a neural network trained with drill bit test data. The numeric algorithm 60 may be generated as a result of the method described above, or it may be from an electronic or other form of trained neural network.

A first input table 64 is a first set of numbers representing drill bit design parameters. A second input table 66 is a plurality of second sets of numbers representing the operating conditions of the drill bit for which the drill bit operating characteristics are desired. Input tables 64 and 66 are lists of numbers ordered in a known pattern. The first input table 64, therefore, is a plurality of ordered numbers that represents the physical design of a drill bit, and the second input table 66 is a plurality of ordered numbers that represent a plurality of operating conditions for the drill bit. These tables may be created in the digital computer by one or more of means well known in the industry. For instance, by keyboard entry by humans, by electronic transfer from a remote digital device by means of a physical numeric storage device such as a floppy disk.

The digital computer 62 transfers the drill bit design parameters from input table 64 to the numeric algorithm. Acting under a set of encoded instructions, the digital computer 62 then transfers a set of ordered numbers representing the drill bit operating conditions from the second table 66 into a number of variables provided for in the numeric algorithm 60. Continuing to act under the set of encoded instructions, the digital computer 62 then causes the numeric algorithm 50 to be executed, producing one or more predicted drill bit operating characteristics based upon the given set of operating conditions. The resulting predicted drill bit operating characteristics are stored as a set of one or more ordered numbers in an output table 68.

The digital computer 62 then transfers the next set of ordered numbers representing drill bit operating conditions from the second table 66 into the numeric algorithm 60 to produce another set of predicted drill bit operating characteristics. The drill bit operating characteristics are stored in a sequential manner in the next position in the output table 68. This is repeated sequentially until each set of ordered numbers representing the drill bit operating conditions from the second input table 66 has been processed by the numeric algorithm into a set of predicted drill bit operating characteristics and stored in a sequential manner in output table 68.

The set of output operating characteristics of the drill bit in table 68 represents the drilling behavior and performance of the drill bit with the given design parameters and set of operating conditions.

Whereas the present invention has been described in particular relation to the drawings attached hereto, it should be understood that other and further modifications apart from those shown or suggested herein, may be made within the scope and spirit of the present invention.

1. A method for predicting at least one operating characteristic of a drill bit, the method comprising:
entering a value for at least two drill bit design parameters into a trained neural network;
entering a value for at least one drill bit operating condition into a trained neural network; and
receiving at least one value for at least one drill bit operating characteristic as output of the trained neural network.

2. The method of claim 1, further including entering values for at least two drill bit operating conditions into the trained neural network.

3. The method of claim 2, further including the neural network characterizing the performance of the drill bit under a variety of operating conditions.

4. The method of claim 1, further including
entering the values for the at least two drill bit design parameters and the at least one drill bit operating condition into a device that can follow instructions to alter data in a desirable way to perform at least some operations without human intervention, and
the device providing the at least one value for at least one drill bit operating characteristic.

5. The method of claim 4, further including
entering a plurality of values of at least one drill bit operating condition into the trained neural network, and
receiving output from the trained neural network indicating a value for at least one drill bit operating characteristic for at least two entered values of the at least one drill bit operating condition.

6. The method of claim 4, further including programming the device with multiple values of the one or more of the drill bit operating conditions, the values incremented over one or more ranges.

7. The method of claim 1, further including evaluating at least one value of the at least one drill bit operating characteristic to determine performance of the drill bit.

8. The method of claim 1, further including evaluating at least one value of at least one drill bit operating characteristic to assist in determining the design of the drill bit.

9. The method of claim 8, further including
evaluating the effect of at least two drill bit design parameters upon the at least one drill bit operating characteristic, and
selecting the at least one drill bit design parameter having the greatest effect upon the at least one drill bit operating characteristic.

10. A method for determining at least one operating characteristic of a drill bit having at least one design parameter and at least one operating condition with the use of an appropriately trained neural network, the method comprising:
determining at least one drill bit design parameter, at least one drill bit operating condition and at least one drill bit operating characteristic;
entering a value for at least one drill bit design parameter and a value for at least one drill bit operating condition into a trained neural network; and
receiving output from the trained neural network indicating at least one value for at least one operating characteristic of a drill bit having the at least one drill bit design parameter and operating condition entered into the trained neural network.

11. The method of claim 10, further including entering values for a plurality of drill bit design parameters and values for a plurality of drill bit operating conditions into the trained neural network.

12. The method of claim 11, wherein the plurality of drill bit design parameters include at least one among the bit diameter, cone volume index 1, cone volume index 2, asymmetry index, drill bit gauge type, shear length index, cut area index, profile length index, profile base moment, profile center moment, gauge ring, profile base 2nd moment, profile center 2nd moment, cut area base moment, cut area center moment, and bit volume index.

13. The method of claim 12, wherein the drill bit is a fixed cutter drill bit.

14. The method of claim 10, wherein the at least one drill bit operating condition includes at least one among the drill bit rpm, weight on bit, rock type, drilling depth, mud weight, build angle, and bent sub angle.

15. The method of claim 10, wherein the at least one drill bit operating characteristic includes at least one among lateral acceleration, torsional acceleration, torque, and longitudinal acceleration.

16. The method of claim 10, further including entering the values for the at least one drill bit design parameter and the at least one drill bit operating condition into a device that can follow instructions to alter data in a desirable way to perform at least some operations without human intervention.

17. The method of claim 16, further including
entering a value for each among a plurality of drill bit operating conditions into the trained neural network, and
receiving output indicating a value for at least one drill bit operating characteristic for at least two entered values of the at least one drill bit operating condition.

18. The method of claim 16, further including
entering a value for each among a plurality of drill bit design parameters into the trained neural network,
evaluating the effect of the drill bit design parameters upon the at least one drill bit operating characteristic, and
selecting at least one drill bit design parameter having the greatest effect upon the at least one drill bit operating characteristic to determine the drill bit design parameters for which values will be entered into the trained neural network.

19. A method for selecting a value of at least one among at least one operating characteristic of a drill bit, at least one design parameter of a drill bit and at least one operating condition of a drill bit with the use of a neural network, the method comprising:
identifying at least one drill bit design parameter, at least one drill bit operating condition and at least one drill bit operating characteristic,
training the neural network with data relating to at least two among at least one drill bit design parameter, at least one drill bit operating condition and at least one drill bit operating characteristic for each among a plurality of drill bits,
entering a value for at least one among at least one drill bit design parameter, drill bit operating condition and drill bit operating characteristic into the trained neural network, and
the neural network providing output useful for predicting at least one among at least one drill bit design parameter, at least one drill bit operating condition and at least one drill bit operating characteristic based upon the entered values.

20. The method of claim 19, further including evaluating the output of the neural network to determine performance of the drill bit.

21. The method of claim 19, further including entering a value for at least two among the at least one drill bit design parameter, drill bit operating condition and drill bit operating characteristic into the trained neural network, and evaluating the output to assist in determining the design of a drill bit.

22. The method of claim 21, further including using the neural network to characterize performance of the drill bit under a variety of operating conditions.

23. The method of claim 19, further including evaluating the output to determine behavior of the drill bit.

24. The method of claim 23, further including
entering a value for at least two drill bit design parameters into the neural network,
evaluating the effect of at least two drill bit design parameters upon at least one drill bit operating characteristic, and
selecting at least one drill bit design parameter having an impact upon at least one drill bit operating characteristic to determine the at least one drill bit design parameter for which values will be entered into the trained neural network.

25. The method of claim 19, further including
entering a plurality of data sets, each data set including a value for a set of drill bit design parameters and at least one drill bit operating condition, and at least one drill bit operating characteristic for each data set,
entering values for a set of drill bit design parameters and at least one drill bit operating condition into the trained neural network, and
generating output from the trained neural network to characterize at least one operating characteristic of a drill bit having the entered values for the drill bit design parameters and at least one operating condition.

26. A method for determining the design of a drill bit, the method comprising:
entering a value for at least two among at least one drill bit design parameter, at least one drill bit operating condition and at least one drill bit operating characteristic into a trained neural network; and
receiving output from the trained neural network to determine at least one drill bit design parameter useful in the design of a drill bit.

27. The method of claim 26, wherein the neural network is trained by inputting into a computing device a value for at least one drill bit design parameter, at least one drill bit operating condition and at least one drill bit operating characteristic for a plurality of drill bits.

28. The method of claim 27, wherein the drill bit is a fixed cutter drill bit.

29. The method of claim 28, wherein the at least one drill bit operating characteristic includes at least one among lateral acceleration, torsional acceleration, torque, and longitudinal acceleration.

30. A method for characterizing the performance of a drill bit, the method comprising:
determining a set of drill bit design parameters and at least one drill bit operating condition;
training a neural network by inputting a plurality of data sets, each data set including a value for a set of drill bit design parameters and at least one drill bit operating condition, and at least one drill bit operating characteristic for each data set;
entering values for a set of drill bit design parameters and at least one drill bit operating condition into the trained neural network; and
generating output from the trained neural network to characterize at least one operating characteristic of a drill bit having the entered values for the drill bit design parameters and at least one operating condition.

31. The method of claim 30, further including entering values for a plurality of operating conditions into the trained neural network.

32. The method of claim 31, wherein the drill bit is a fixed cutter drill bit.

33. The method of claim 32, further including
entering the values for the drill bit design parameters and at least one drill bit operating condition into a device that can follow instructions to alter data in a desirable way to perform at least some operations without human intervention, and
the device providing the output.

34. The method of claim 33, further including programming the device such that one or more of the at least one drill bit operating condition is incremented over one or more ranges to predict the overall drilling behavior of the drill bit.

35. The method of claim 30, further including evaluating the output to assist in determining the design of the drill bit.

36. The method of claim 35, wherein the drill bit is a fixed cutter drill bit.

37. The method of claim 36, further including
entering a plurality of values of at least one drill bit operating condition into the trained neural network, and
receiving output from the trained neural network indicating a value for at least one drill bit operating characteristic for each entered value of the at least one drill bit operating condition.

38. A method for determining the best fit between at least one drill bit operating characteristic and at least one among at least one drill bit design parameter and at least one drill bit operating condition, the method comprising:
entering a value for at least one among at least one drill bit design parameter and at least one drill bit operating condition into a trained neural network; and
receiving output from the trained neural network indicating a value for at least one drill bit operating characteristic of a drill bit having the entered values.

39. The method of claim 38, further including evaluating the output to determine the best fit of at least one drill bit operating characteristic with at least one drill bit design parameter and at least one drill bit operating condition.

40. The method of claim 39, further including entering a value for each among a plurality of drill bit design parameters and a plurality of drill bit operating conditions.

41. A method for predicting the drilling behavior of a drill bit, the method comprising:
entering a plurality of values of at least one drill bit operating condition into a trained neural network; and
receiving output from the trained neural network indicating a value for at least one drill bit operating characteristic for each entered value of the at least one drill bit operating condition.

42. A method for selecting at least one drill bit design parameter for assisting in determining the usefulness of a drill bit, the method comprising:
training a neural network with values of at least two drill bit design parameters and at least one drill bit operating characteristic;
evaluating the sensitivity of at least two drill bit design parameters upon the at least one drill bit operating characteristic; and
determining which at least one drill bit design parameter has the greatest effect on accurately predicting at least one drill bit operating characteristic.
